(19) United States
(12) Patent Application Publication
(10) Pub. No.: US 2004/0159519 A1
(43) Pub. Date: Aug. 19, 2004

(54) Clutch reaction plates with cooling flow path

(76) Inventors: Michael J. Gorman, Ann Arbor, MI (US); Young Sik Kim, Canton, MI (US)

Correspondence Address: LESLIE C. HODGES, General Motors Corporation, Legal Staff, Mail Code 482-C23-B21, P.O. Box 300, Detroit, MI, 48265-3000, US

(21) Appl. No.: 10/366,911

(22) Filed: Feb. 14, 2003

(51) Int. Cl. F16D 25/0638; F16D 25/064

(52) U.S. Cl. 192/70.12; 192/70.14; 192/107 R; 192/107 M; 192/113.36

(57) ABSTRACT

A reaction plate for a transmission clutch pack includes first and second steel disks each having a contact surface facing the other of the two steel disks and having inner and outer peripheral edges. Each contact surface has grooves formed therein to carry cooling fluid from the inner peripheral edge to the outer peripheral edge to enhance cooling.

### TECHNICAL FIELD

The present invention relates to clutch reaction plates which include facing disks having grooves formed in the facing surfaces to facilitate flow of oil from the inner periphery to the outer periphery of the reaction plates for cooling.

### BACKGROUND OF THE INVENTION

In a so-called “wet” clutch for an automatic transmission, friction plates and reaction plates are typically alternately stacked or interleaved. The friction plates are typically splined at an inner periphery, and the reaction plates are splined at an outer periphery. Accordingly, when the plates are compressed together, frictional engagement between the plates causes the plates to rotate together, thereby transmitting torque between the inner and outer splined interfaces of the plates.

As the clutches are engaged and disengaged, a significant amount of heat energy is generated. This heat energy must be dissipated at a rate which allows the surface temperatures of the plates to be contained within the working limits of the friction materials on the friction plates. The rate of dissipation of heat from the plates accordingly affects performance characteristics of a transmission. For example, if a transmission is required to launch a heavily loaded truck traveling up a steep incline, then torque carrying capacity must be enhanced. The torque carrying capacity is typically increased by increasing the radius of the friction plates to increase the effective lining area. However, this increase in radius of the friction plates adds size and cost to the assembly, and also requires additional cooling oil to be transferred across the plates for cooling. This heat problem is particularly exacerbated when launching a heavily-laden vehicle uphill because the friction plates experience high slip speed at high torque for an extended period of time.

### SUMMARY OF THE INVENTION

The invention provides an improved clutch reaction plate including two facing disks with cooling grooves formed therein to enable cooling fluid to pass through the reaction plate to enhance heat dissipation. Accordingly, cooling flow is provided as closely as possible to the source of the heat generation, which is the interface between the steel surface of the reaction plates and the friction plates. The reaction plate disks are made from steel stock having one smooth side and one side with a rolled, coined or otherwise formed half-passage to accommodate radial flow of cooling oil.

By assembling pairs of steel plates or disks with the smooth surfaces outward and the formed sides facing each other, it is possible to increase the mass flow rate of cooling oil radially through the steel plates, even with the clutch pack fully clamped.

This invention enables a higher duty cycle with improved durability and reliability through increased energy dissipation rates. It offers the potential to reduce clutch size or to operate clutches of existing size at higher energy throughput rates.

More specifically, the present invention provides a reaction plate for a transmission clutch pack, including first and second steel disks each having a contact surface facing the other of the two steel disks and having inner and outer peripheral edges. Each contact surface has grooves formed therein to carry cooling fluid from the inner peripheral edge to the outer peripheral edge to enhance cooling.

Preferably, the steel disks are made of SAE 1020 steel, and the grooves are approximately 0.25-0.50 mm in depth (0.010-0.020 inch). The grooves are preferably semi-circular in cross-section and the grooves of the first plate are aligned with the grooves of the second plate. Also the grooves preferably extend radially from the respective inner peripheral edge to the respective outer peripheral edge.

The invention further provides a clutch pack for a transmission including a plurality of internally splined friction plates alternately stacked or interleaved with a plurality of externally splined reaction plates. Each reaction plate is constructed of first and second disks as described above with grooves to facilitate transfer of cooling oil for heat dissipation.

The invention also provides a method of enhancing performance of a clutch pack including a plurality of friction plates alternately stacked or interleaved with a plurality of reaction plates. The method includes replacing each reaction plate with a replacement reaction plate configured as described above with first and second facing disks having grooves formed therein to enhance flow of cooling oil to facilitate heat transfer.

The above objects, features and advantages and other objects, features and advantages of the present invention are readily apparent from the following detailed description of the best mode for carrying out the invention when taken in connection with the accompanying drawings.

### BRIEF DESCRIPTION OF THE DRAWINGS

FIG. 1 shows a perspective view of a steel disk for use in a clutch reaction plate in accordance with the invention.

FIG. 2 shows a plan view of the steel disk of FIG. 1.

FIG. 3 shows a sectional view taken at line 3-3 of FIG. 2.

FIG. 4 shows a perspective view of a reaction plate in accordance with the invention.

FIG. 5 is a longitudinal cross-sectional view of a clutch pack in a transmission incorporating the reaction plates of the present invention.

### DESCRIPTION OF THE PREFERRED EMBODIMENT

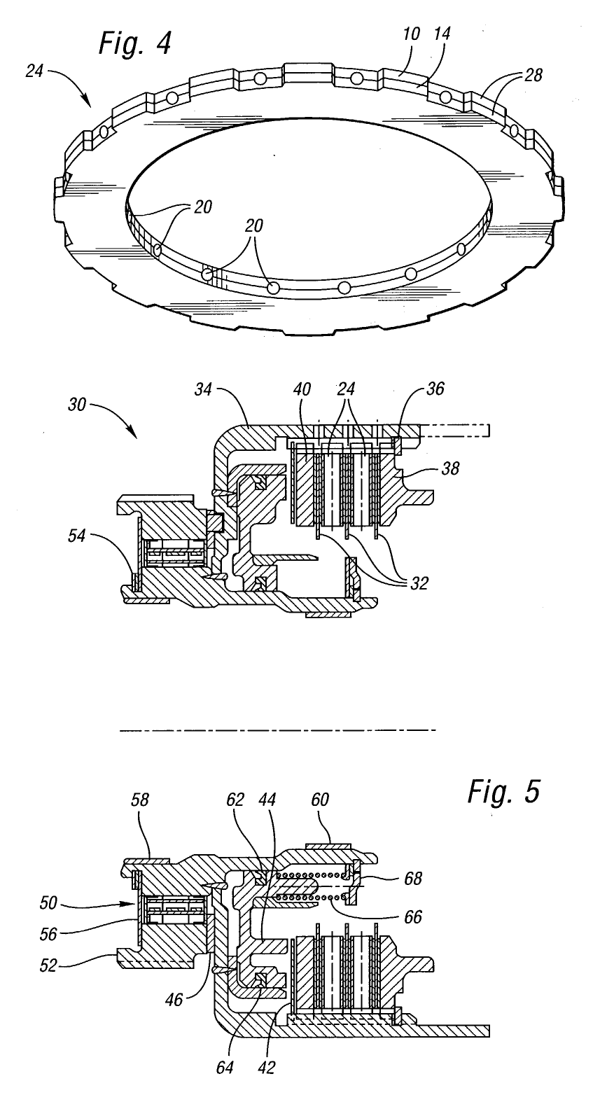

The invention provides a reaction plate for use in a transmission clutch pack. The reaction plate comprises first and second steel disks, which are mirror images of each other. Referring to FIGS. 1-3, an exemplary first steel disk 10 is shown. The steel disk 10 is preferably a SAE 1020 steel component having a contact surface 12 configured to contact the second steel disk 14, shown in FIG. 4. The first steel disk 10 has inner and outer peripheral edges 16, 18, respectively. Also, a plurality of grooves 20 are formed in the contact surface 12 to carry fluid from the inner peripheral edge 16 to the outer peripheral edge 18 to enhance cooling.

The grooves 20 may be coined, rolled, or otherwise formed in the contact surface 12 of the first and second disks 10, 14.

As shown in FIG. 1, the grooves 20 are semi-circular in cross-section so that when the first and second steel disks 10, 14 contact each other to form the reaction plate 24, as shown in FIG. 4, the grooves 20 are aligned and form cylindrical apertures for carrying fluid from the inner peripheral edge 16 to the outer peripheral edge 18.

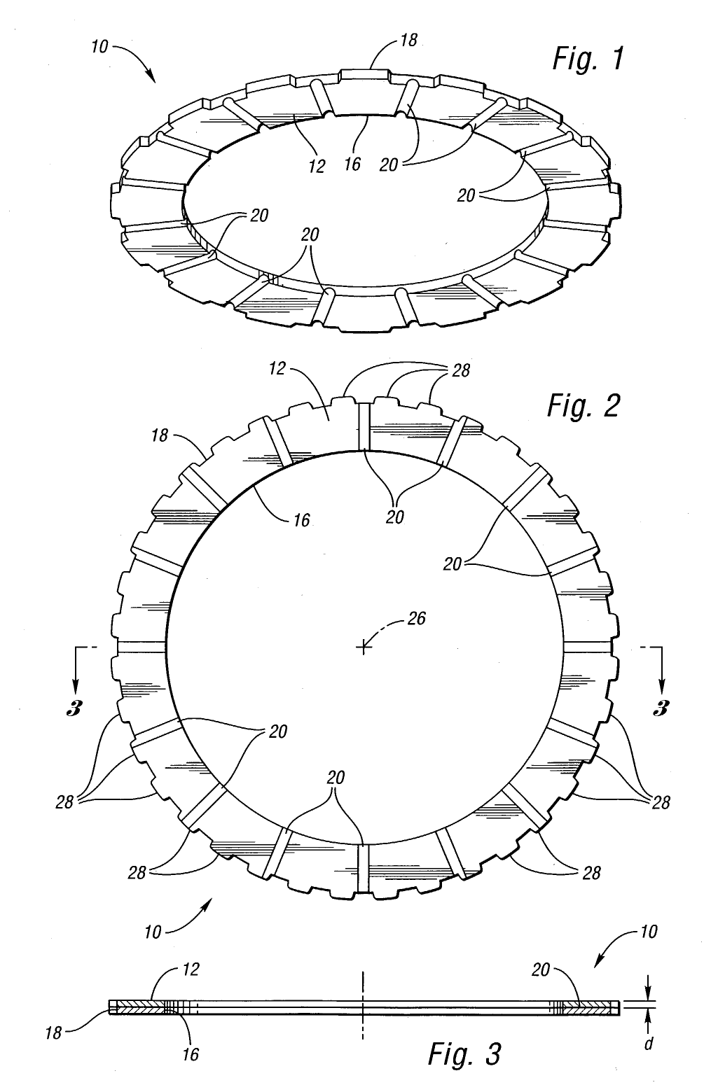

As shown in FIG. 3, the grooves 20 preferably have a depth (d) between approximately 0.25 and 0.50 millimeters. As shown in FIG. 2, the grooves 20 extend radially from the center of rotation 26 of the disks.

As further shown in FIGS. 1-4, the first and second steel disks 10, 14 include external splines 28 for transmitting torque to a rotating drum.

Referring to FIG. 5, a cross-sectional view of a clutch assembly 30 is shown for use in an automatic transmission in accordance with the present invention. The clutch assembly 30 includes the reaction plates 24 which are interleaved or alternately stacked with the friction plates 32. Each reaction plate 24 is configured as shown in FIGS. 1-4.

As shown in FIG. 5, the friction plates 32 each include a friction lining on each side thereof, as is known in the art. The friction materials may be paper, elastomer, graphite, sintered metal, etc. The splines of the reaction plates 24 are splined to the clutch input shell or drum 34, which is a weldment. The clutch pack assembly includes a reaction plate retaining ring 36 which is slotted into the clutch input shell 34 for retaining the stationary reaction member 38. An apply plate 40 is positioned at the opposing side of the interleaved plates 24, 32, and is biased by a cushion spring 42, and acted upon by the apply piston 44. A thrust washer 46 separates the clutch input shell 34 from the sprag member 52. A snap ring 54 and sprag retainer 56 are also shown.

Bushings 58, 60, and lip seals 62, 64 are also shown.

The assembly also includes a piston return spring 66 and return spring guide assembly 68 are also illustrated.

The reaction plates of the invention are implemented in the above described transmission clutch assembly, by way of example only. By forming the reaction plates as an assembly of two facing disks having grooves formed therein, the benefits of the invention are achieved. The grooves may or may not align with each other, and the grooves may take a variety of different shapes, such as parallel grooves, spiral grooves, etc.

The invention enables a higher rate of energy input into the interface because heat energy is better dissipated from the interface. This makes the clutch pack more robust because the cooling fluid is brought very close to the source of the heat (i.e., the frictional interface at the metal surfaces of the reaction plates).

The invention may also allow elimination of grooves formed in the friction pads on the friction plates to gain surface area for friction material, which may enable elimination of plates or reduction of the plate radius. Accordingly, the invention increases the effective lining area, and enables an increase in the applied clamp load, which allows more torque to be carried in the same size clutch, or enables the size of the clutch plates to be reduced.

The disks forming the reaction plates are preferably manufactured from a fine blanking operation.

Further, the grooves formed in the plates need not be semi-circular. They could be square, rectangular, or any other desired shape, but semi-circular would be preferred.

The invention also contemplates a method of enhancing performance of a clutch pack by replacing existing reaction plates with replacement reaction plates manufactured as pairs of first and second disks having grooves formed therein, as described above.

While the best mode for carrying out the invention has been described in detail, those familiar with the art to which this invention relates will recognize various alternative designs and embodiments for practicing the invention within the scope of the appended claims.

1. A reaction plate for a transmission clutch pack, comprising:
first and second steel disks each having a contact surface facing the other of said two steel disks and having inner and outer peripheral edges, wherein each contact surface has grooves formed therein to carry cooling fluid from the inner peripheral edge to the outer peripheral edge to enhance cooling.

2. The reaction plate of claim 1, wherein said steel disks comprise SAE 1020 steel.

3. The reaction plate of claim 1, wherein said grooves are each approximately 0.25 to 0.50 mm in depth.

4. The reaction plate of claim 1, wherein grooves of said first plate are aligned with grooves of said second plate.

5. The reaction plate of claim 4, wherein said grooves extend radially from the respective inner peripheral edge to the respective outer peripheral edge.

6. The reaction plate of claim 1, wherein each said groove is semi-circular in cross-section.

7. The reaction plate of claim 1, wherein said grooves are coined.

8. A clutch pack for a transmission comprising:
a plurality of internally splined friction plates; and
a plurality of externally splined reaction plates alternately stacked with said friction plates, each said reaction plate including first and second steel disks each having a contact surface facing the other of said two steel disks and having inner and outer peripheral edges, wherein each contact surface has grooves formed therein to carry cooling fluid from the inner peripheral edge to the outer peripheral edge to enhance cooling.

9. The clutch pack of claim 8, wherein said steel disks comprise SAE 1020 steel.

10. The clutch pack of claim 8, wherein said grooves are each approximately 0.25 to 0.50 mm in depth.

11. The clutch pack of claim 8, wherein grooves of said first plate are aligned with grooves of said second plate.

12. The clutch pack of claim 8, wherein said grooves extend radially from the respective inner peripheral edge to the respective outer peripheral edge.

13. The clutch pack of claim 8, wherein each said groove is semi-circular in cross-section.

14. The clutch pack of claim 8, wherein said grooves are coined.

15. A method of enhancing performance of a clutch pack including a plurality of friction plates alternately stacked with a plurality of reaction plates, the method comprising:
replacing each reaction plate with a replacement reaction plate including first and second steel disks each having a contact surface facing the other of said two steel disks and having inner and outer peripheral edges, wherein each contact surface has grooves formed therein to carry cooling fluid from the inner peripheral edge to the outer peripheral edge to enhance cooling.
